(19) United States
(12) Patent Application Publication
(10) Pub. No.: US 2010/0018814 A1
(43) Pub. Date: Jan. 28, 2010

(54) VEHICLE WHEEL ASSEMBLY, BRAKE CALIPER ASSEMBLY AND RELATED METHODS

(76) Inventor: Jonathan O. Pagles, Winter Park, FL (US)

Correspondence Address: HERBERT L. ALLEN;ALLEN, DYER, DOPPELT, MILBRATH & GILCHRIST, P.A., 255 SOUTH ORANGE AVENUE, SUITE 1401, P. O. BOX 3791, ORLANDO, FL, 32802-3791, US

(21) Appl. No.: 12/548,972

(22) Filed: Aug. 27, 2009

Related U.S. Application Data
(63) Continuation-in-part of application No. 12/498,343, filed on Jul. 6, 2009.
(60) Provisional application No. 61/077,899, filed on Jul. 3, 2008.

(51) Int. Cl. B60T 1/06; F16D 65/833; B23P 6/00

(52) U.S. Cl. 188/18 A; 188/264 D; 29/402.08

(57) ABSTRACT

A vehicle wheel assembly includes a hub carrier, a hub rotatable relative. to the hub carrier about a hub axis, a brake rotor releasbly secured to the hub, a wheel rim releasably secured to the hub, a mounting mechanism releasably engaged to secure the wheel rim and the brake rotor to the hub, and a brake caliper assembly slidably mounted to the hub carrier and adapted to selectively engage the brake rotor using brake pads. With the mounting mechanism disengaged, the brake caliper assembly is slidably displaceable such that the brake rotor can be removed from the hub without removing the brake caliper assembly from the hub carrier.

### CROSS-REFERENCE TO RELATED APPLICATIONS

This application is a continuation-in-part of U.S. patent application Ser. No. 12/498,343, filed on Jul. 6, 2009, which claims the benefit of U.S. Provisional Application Ser. No. 61/077,899, filed on Jul. 3, 2008, the contents of which applications are herein incorporated by reference in their entirety.

### BACKGROUND OF THE INVENTION

Brakes are vital to the safe operation of many vehicles. Additionally, in racing applications, superior-performing brakes can mean the difference between victory and defeat. One manner in which it has been attempted to enhance brake performance is by providing active fluid cooling to brake calipers. Some of these systems attempt to provide such cooling by cooling of the brake fluid. However, during period in which the brakes are not actively in use, the cooling performance of such systems suffers. Also, leaks in the components used to cool the brake fluid could result in an overall loss of braking capability.

In intensive braking applications, such as racing, it is also known to periodically change the brake pads as the pads wear. However, due to the difficulty and time required to change brake rotors, rotors are expected to last an entire race. Significant warping of brake rotors has been known to occur over the course of a single race, resulting in reduced brake performance even with new pads.

Auto hobbyists and do-it-yourselfers also change brake pads and rotors for non-race vehicles. However, such maintenance can be extremely time-consuming, often requiring bleeding of the brakes and removal of several brake system components.

### SUMMARY OF THE INVENTION

Based on the foregoing, it is an object of the present invention to provide an improved vehicle wheel assembly, brake caliper assembly and related methods.

According to an embodiment of the present invention, a vehicle wheel assembly includes a hub carrier, a hub rotatable relative to the hub carrier about a hub axis, a brake rotor releasably secured to the hub, a wheel rim releasably secured to the hub, a mounting mechanism releasably engaged to secure the wheel rim and the brake rotor to the hub, and a brake caliper assembly slidably mounted to the hub carrier and adapted to selectively engage the brake rotor using brake pads. With the mounting mechanism disengaged, the brake caliper assembly is slidably displaceable such that the brake rotor can be removed from the hub without removing the brake caliper assembly from the hub carrier.

According to an aspect of the present invention, a brake caliper assembly includes a caliper body having a cylinder defined therein, a piston arranged therein and adapted to selectively displace a brake pad to engage brake rotor, a caliper mounting post adapted for slidably mounting the caliper body to a hub carrier of a vehicle wheel assembly. The caliper mounting post is dimensioned to allow sufficient slidable displacement of the caliper body relative to the hub carrier such that the brake rotor can be removed from the vehicle wheel assembly without removal of the brake caliper assembly from the hub carrier.

According to a method aspect of the present invention, a method of using a vehicle wheel assembly includes disengaging the mounting mechanism, removing the wheel rim, simultaneously pulling the brake rotor and the brake caliper assembly away from the hub, and moving the brake rotor clear of the brake caliper assembly when the brake rotor is clear of the hub.

Further aspects of the present invention include a pneumatic piston press for forcibly retracting the caliper piston and a cooling system for the caliper assembly including a removable caliper head.

These and other objects, aspects and advantages of the present invention will be better understood in view of the drawings and detailed description of preferred embodiments.

### BRIEF DESCRIPTION OF THE DRAWINGS

FIG. 1 is a front view of a vehicle wheel assembly, according to an embodiment of the present invention, with a brake rotor and wheel rim removed to show details;

FIG. 2 is a front view of the assembly of FIG. 2, with the brake rotor in place;

FIG. 3 is a front view of the assembly of FIG. 2, with the wheel rim shown in partial cutaway;

FIG. 4 is a schematic, sectional side view of the wheel assembly of FIGS. 1-3, in a fully-assembled state;

FIG. 5 is a schematic front view of the wheel assembly of Figures 1-3, in a fully-assembled state, with hidden components shown in broken lines;

FIG. 6 is a top view of the wheel assembly of FIGS. 1-3 in a fully-assembled state, with hidden components shown in broken lines and some components shown in partial cutaway and section;

FIG. 7 is a FIG. 4 is a schematic, sectional side view of the wheel assembly of FIGS. 1-3, in an intermediate state;

FIG. 8 is a schematic front view of the wheel assembly of FIGS. 1-3, in an intermediate state, with hidden components shown in broken lines;

FIG. 9 is a top view of the wheel assembly of FIGS. 1-3 in an intermediate state, with hidden components shown in broken lines and some components shown in partial cutaway and section;

FIG. 10 is a schematic, sectional side view of the wheel assembly of FIGS. 1-3, with the wheel rim and brake rotor removed;

FIG. 11 is a schematic front view of the wheel assembly of FIGS. 1-3, with the wheel rim and brake rotor removed, with hidden components shown in broken lines;

FIGS. 12 and 13 are front views of a vehicle wheel assembly in alternate positions, according to another embodiment of the present invention, with a brake rotor and wheel rim removed to show details;

FIG. 14 is a front view of a vehicle wheel assembly, according to an additional embodiment of the present invention, with a wheel rim shown in partial cutaway;

FIG. 15 is a perspective view of a brake rotor of the assembly of FIG. 14;

FIG. 16 is a sectional view of components of the wheel rim and brake rotor of FIG. 14, with an alternate position shown in broken lines;

FIG. 17 is a perspective view of a piston caliper press, according to an aspect of the present invention;

FIGS. 18 and 19 are schematic side views of the press of FIG. 17 in alternate positions;

FIG. 20 is a rear view of a brake caliper assembly, including a caliper body and a caliper head;

FIG. 21 is a rear view of the caliper body of FIG. 20, with the caliper head removed;

FIG. 22 is a front view of the caliper head of FIG. 20; and

FIG. 23 is a schematic overview of a cooling system for the brake caliper of FIG. 20.

### DETAILED DESCRIPTION OF PREFERRED EMBODIMENTS

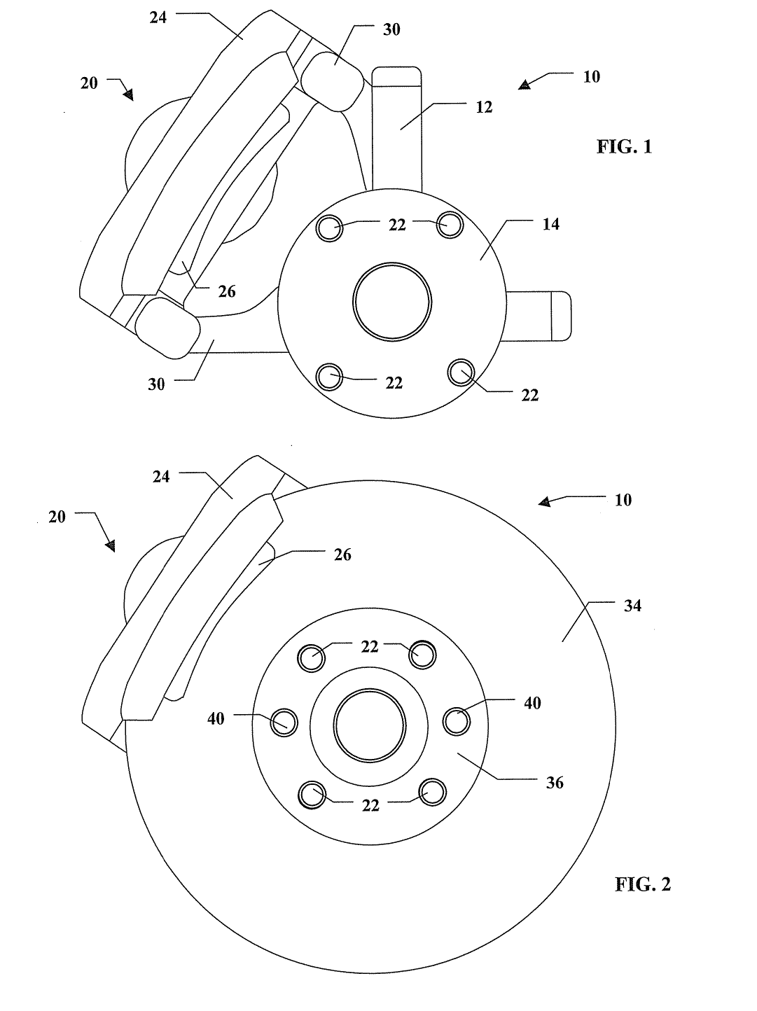

Referring to FIG. 1, according to an embodiment of the present invention, a vehicle wheel assembly 10 includes a hub carrier 12, a hub 14 and a brake caliper assembly 20. The hub 12 is connected to a vehicle (not shown) according to and of various vehicle wheel suspension systems known in the art. The hub 14 is rotatably relative to the hub carrier 12 about a hub axis and has hub bolts 22 extending outwardly therefrom. The brake caliper assembly 20, which will be described in greater detail below, includes a caliper body 24 with brake pads 26 displaceably supported therein. As will be appreciated from the following, the brake caliper assembly 20 is slidably mounted to caliper mounting arms 30 of the hub carrier 12.

Referring to FIG. 2, the vehicle wheel assembly 10 further includes a brake rotor 34 with a central portion 36 mounted over the hub bolts 22. The brake pads 26 of the caliper assembly 20 are adapted to releasably engage the brake rotor 34 to supply braking action. A plurality of rotor bolts 40 extend from the brake rotor 34 and form a part of an attachment mechanism, as will be described in greater detail below.

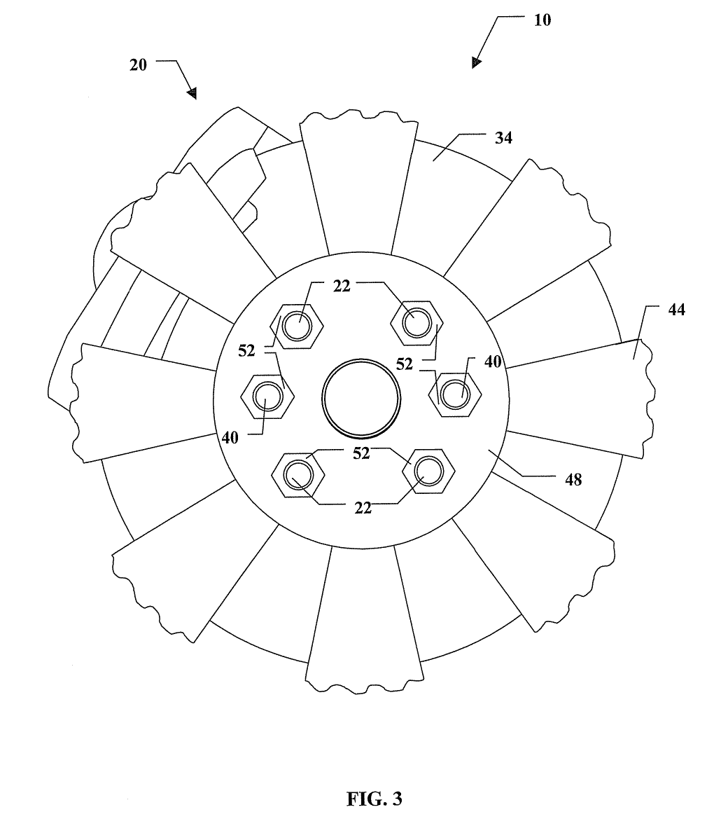

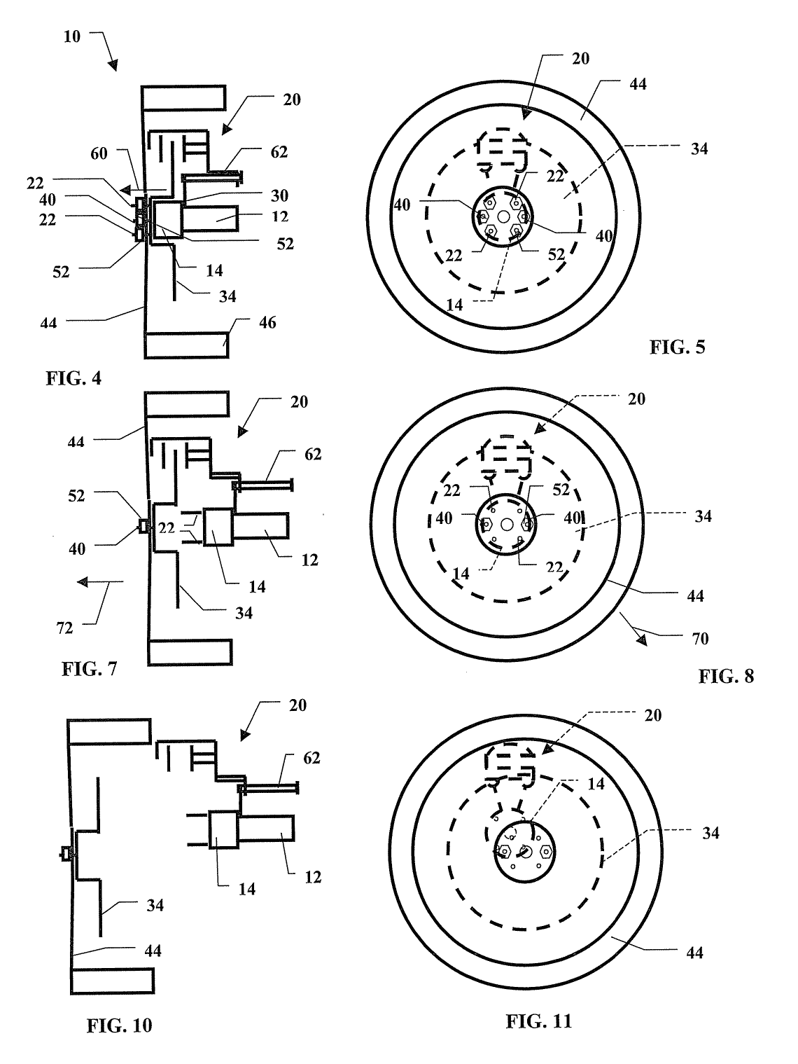

Referring to FIG. 3, the vehicle wheel assembly 10 additionally includes a wheel rim 44 covering the brake rotor 34 and caliper assembly 20 and holding a tire 46 (see FIG. 4). A central portion 48 of the wheel rim 44 is mounted over the hub bolts 22 and rotor bolts 40, and releasably secured thereto with a plurality of nuts 52.

The hub bolts 22 and corresponding nuts 52 form a mounting mechanism that allows the brake rotor 34 and wheel rim 44 to be releasably secured to the hub 14 and rotatable therewith. Other mounting mechanism could also be employed, for instance a central threaded stem extending from the hub and a single threaded collar securable thereabout.

The rotor bolts 40 and corresponding nuts 52 form an attachment mechanism that allows the brake rotor 34 to be releasably secured to the wheel rim 44 independently of the mounting mechanism. By removing all the nuts 52, the wheel rim 44 can be removed without the rotor 34. By removing only the nuts 52 corresponding to the hub bolts 22, the brake rotor 34 and wheel rim 44 can be removed as a unit. Similarly, the brake rotor 34 can be independently secured to the wheel rim 44 prior to engaging the mounting mechanism.

The slidable mounting of the brake caliper assembly 20 to the hub carrier 12 greatly facilitates the removal and replacement of the brake rotor 34. The operation of the vehicle wheel assembly 10 during removal of the brake rotor 34 and wheel rim 44 will be explained in greater detail with reference to FIGS. 4-11. Referring initially to FIGS. 4-6, the vehicle wheel assembly 10 is fully assembled, with the brake rotor 34 and wheel rim 44 mounted over the hub bolts 22 and secured by nuts 52. Additionally, the wheel rim 44 and brake rotor 34 are secured by rotor bolts 40 and corresponding nuts 52.

To being the brake rotor 34 removal process, the nuts 52 are removed from the hub bolts 22. Line 58 represents the location of the forward edge of the hub bolts 22. With the nuts 52 removed from the hub bolts, the brake rotor 34 and wheel rim 44 are moved as a unit in the direction of arrow 60. It will be appreciated that if it were desired to remove only the wheel rim 44, all nuts 52 would be removed.

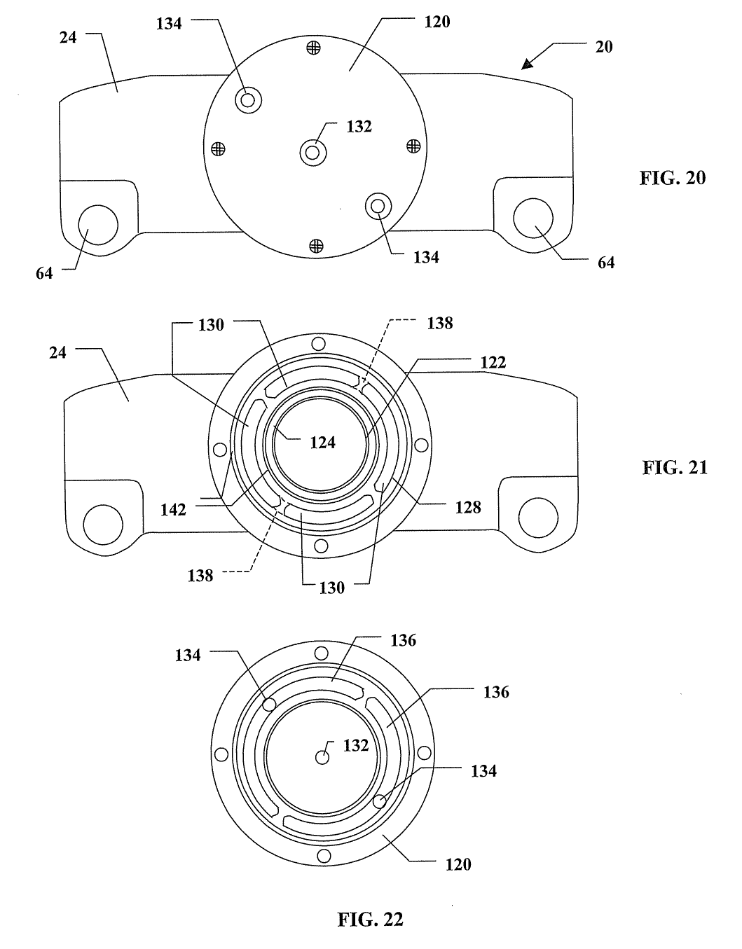

The brake caliper assembly 20 is slidably mounted on caliper mounting posts 62 extending outwardly from mounting arms 30 of the hub carrier 12. The posts 62 extend through mounting bores 64 defined in the caliper assembly 20 (see FIG. 20) and allow the caliper assembly 20 to slide in a direction substantially parallel with the hub axis, although alternate sliding directions are possible.

After sliding as far as permitted by the posts 62 and bored 64 (see distance 66 in FIG. 9) in the direction of arrow 60, the wheel rim 44 and brake rotor 34 are in the position shown in FIGS. 7-9. As will be appreciated particularly from FIGS. 7 and 9, the sliding of the caliper assembly 20 has allowed the brake rotor 34 to clear the forward edge of the hub bolts 22 (see line 58 in FIG. 9). Accordingly, the wheel rim 44 and brake rotor 34 can be completely removed by sliding approximately in the direction of arrows 70 and 72, resulting in the position shown in FIGS. 10 and 11. To replace the wheel rim 44 and brake rotor 34, or to put on a new rim and rotor, the foregoing steps are essentially repeated in reverse. Advantageously, the brake rotor 34 and wheel rim 44 can be connected in advance, such that two steps are not required to mount these components.

Although it has been found advantageous to set the distance 66 sufficiently far to allow the rear surface of the brake rotor 34 to clear the hub bolts 22, this is not necessarily a limitation. Additionally, the present invention is not necessarily limited to sliding the brake caliper assembly 20 in a direction substantially parallel to the hub axis.

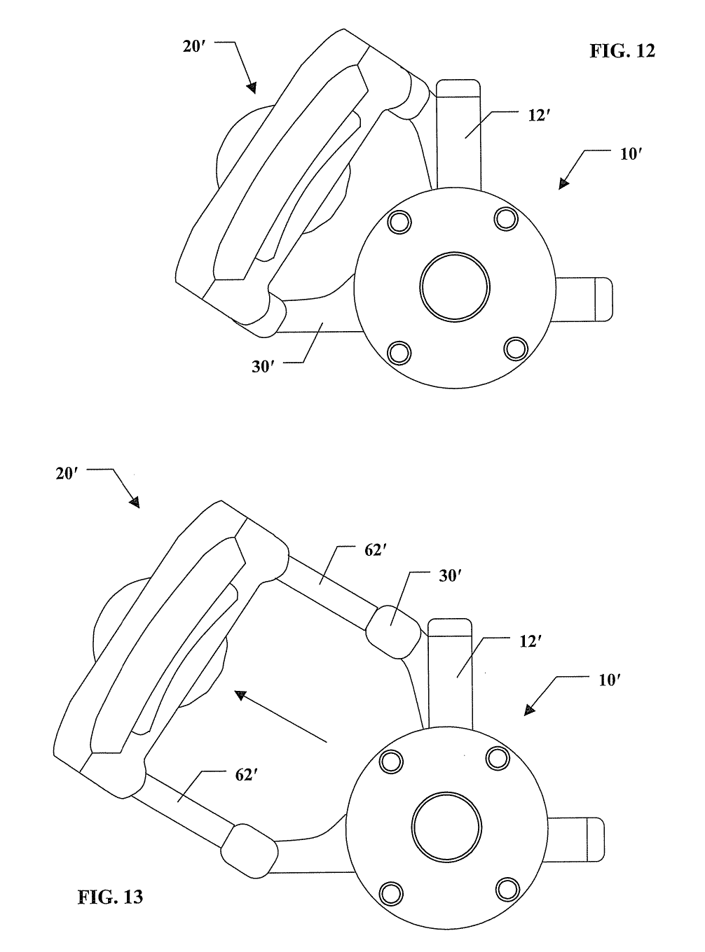

For instance, referring to FIGS. 12 and 13, according to a further embodiment of the present invention, a vehicle wheel assembly 10′ includes a hub carrier 12′ and a brake caliper assembly 20′. The caliper assembly 20′ is slidably mounted to arms 32′ of the hub carrier 12 by caliper mounting posts 62′. The caliper assembly 20′ is slidably displaceable thereby in a direction substantially perpendicular to the hub axis. With the vehicle wheel assembly 10′, similar benefits are achievable as the with the wheel assembly 10. Additionally, the caliper assembly 20′ be slidably displaced before unbolting the wheel rim. This displacement can be automated, if desired.

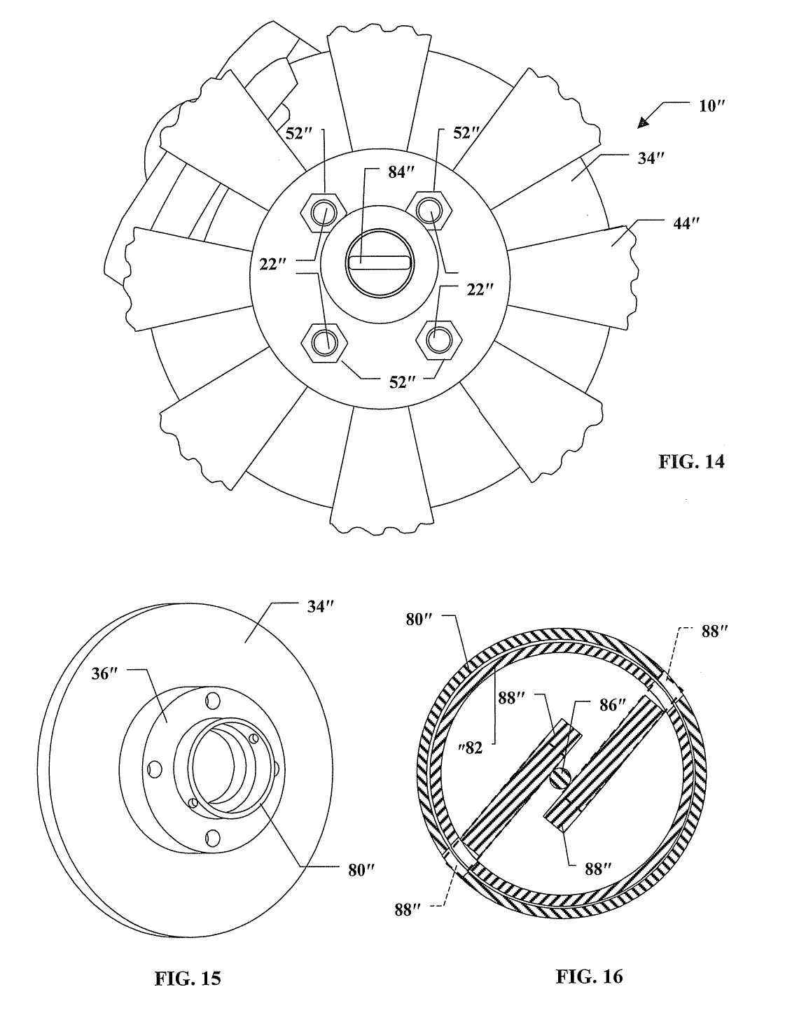

Also, the present invention is not necessarily limited to using the rotor bolts 40 and corresponding nuts 52 as an attachment mechanism, and an attachment mechanism could be omitted altogether. Referring to FIGS. 14-16, a vehicle wheel assembly 10″ includes a brake rotor 34″ and wheel rim 44″. A plurality of hub studs 22 extend through the rotor 34″ and rim 44″ to releasably secure the rotor and rim to the hub in cooperation with the nuts 52″. Rather than rotor bolts and corresponding nuts, an outwardly extending rotor color 80″ nests with an inwardly extending rim collar 82″. A handle 84″, connected to a post 86″, is rotatable to extend locking bars 88″ through aligned openings in the collars 80″, 82″.

The attachment mechanism of the vehicle wheel assembly 10″ allows the brake rotor 34″ and wheel rim 44″ to be independently secured in a relatively quick and easy manner. Additionally, the removal of additional nuts 52 is not needed if only the wheel rim 44″ is to be removed.

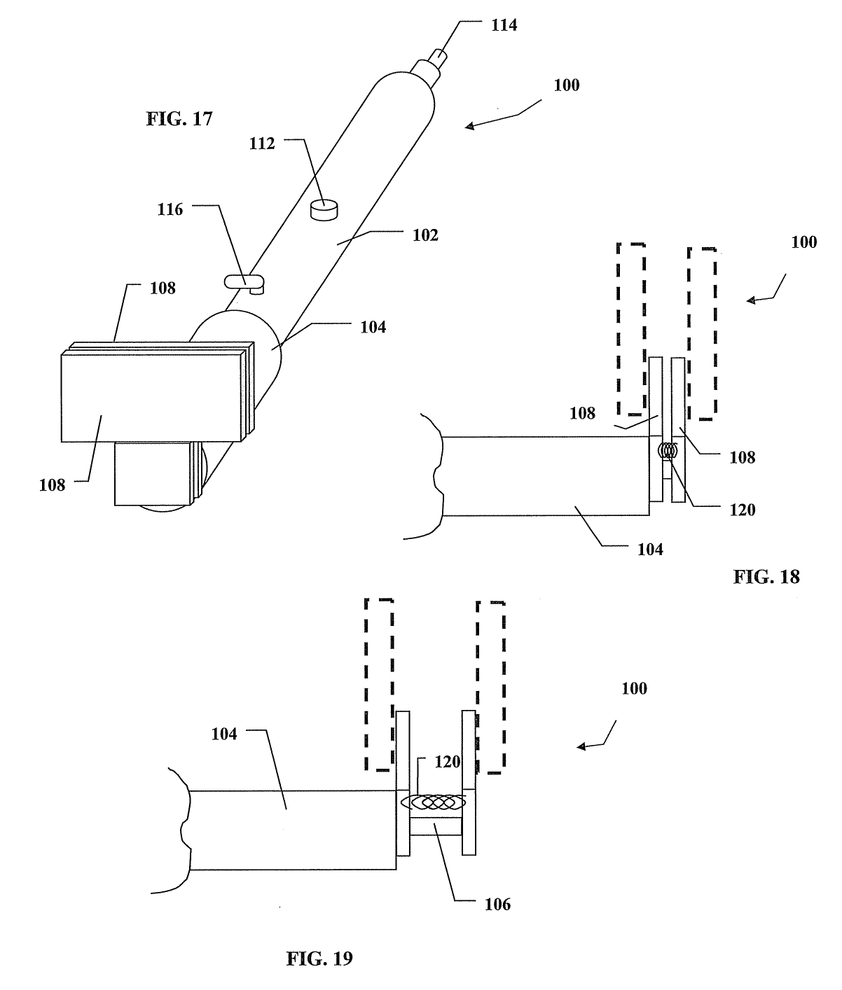

Before replacement of a brake rotor, and also in connection with changing brake pads, it is often necessary to cause the caliper piston to retract, either with or without brake pad(s) attached thereto. Without some manner to forcibly retract the piston, it can be necessary to bleed the brake fluid. According to an aspect of the invention, referring to FIGS. 17-19, a pneumatic piston press 100 includes a handle 102, a pneumatic ram cylinder 104, ram 106 and pressure plates 108.

The handle 102 has an actuator 112 located thereon for selectively porting high pressure air from an air inlet 114 to the cylinder 104 and for allowing air to exit from the cylinder 104 via a vent 116. The ram 106 is operable under pressure from the cylinder 104 to separate the pressure plates 108. A spring 120 can be included to assist in retracting the ram after venting of air from the cylinder 104.

In operation, with reference to FIGS. 18 and 19, the pressure plates 108 are inserted between brake pads (shown in broken lines) and the actuator 112 is operated to vent air to the cylinder 104, extending the ram 106 to separate the plates 108. As a result the pads are separated and the caliper piston is forcibly retracted.

Referring to FIGS. 20-22, the brake caliper assembly 20 will be described in greater detail, according to a further aspect of the present invention. The assembly 20 includes the caliper body 24 and a removable caliper head 120. A cylinder 122 is defined within the body 24 and a piston 124 is slidably arranged within the cylinder 122. A cooling fluid passage 128 is also defined within the body 24 in sections 130 approximately concentric with the cylinder 122.

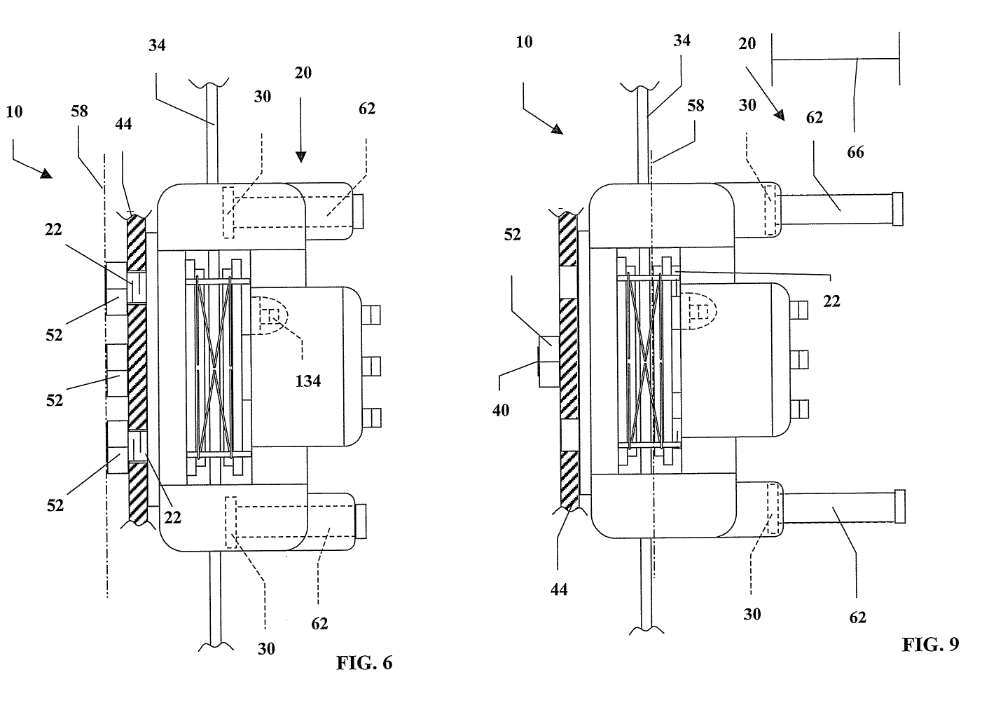

A brake fluid port 132 is defined extending through the head 120 in communication with the cylinder 122, such that brake fluid can be applied to operate the piston 124, as is known in the art. Cooling fluid ports 134 are also defined extending through the head 120, such that cooling fluid can be introduced to, and removed from, the passage 128. Channels 136 are preferably formed in the head 120 to allow communication from each fluid port 134 to multiple sections 130. Channels 138 can be used to connect distal ends of the sections 130, such that fluid can flow in through some sections and then travel out through other sections. Alternately, one or more of the fluid ports 134 could be located on the body 24 apart from the head 120 (see FIG. 6). Additionally, one or more o-rings 142, with corresponding grooves, can be arranged between around the fluid passage 128 and between the fluid passage 128 and the cylinder 122.

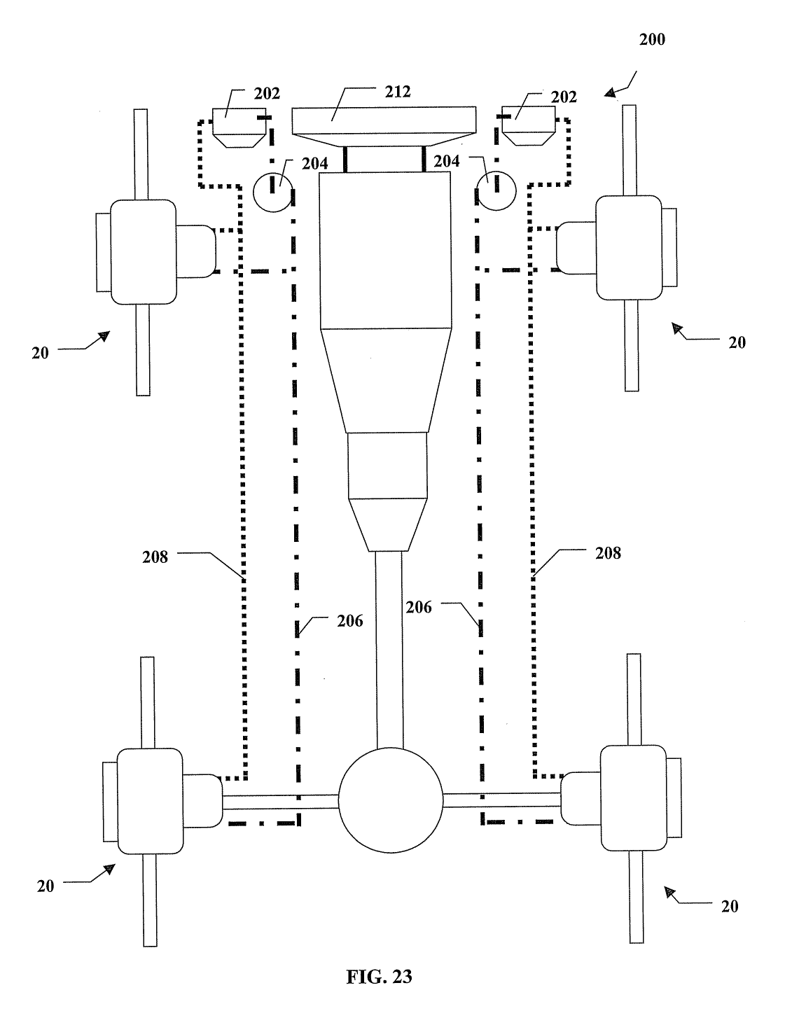

Referring to FIG. 23, a plurality of brake caliper assemblies 20 can be included in a brake cooling system 200. The system 200 further radiators 202 for removing excess heat from the cooling fluid and pumps 204 for supplying the cooling fluid under pressure to the caliper assemblies 20. Cooling fluid supply headers 206 extend from the radiators 202 to the caliper assemblies 20 and cooling fluid return headers 208 extend from the caliper assemblies 20 to the radiators 202. Alternately, a single radiator 202 and pump 204 could be used to supply all the caliper assemblies 20, the system 200 could share a radiator 212 and/or pump with other vehicle cooling loads.

In general, the foregoing description is provided for exemplary and illustrative purposes; the present invention is not necessarily limited thereto. Rather, those skilled in the art will appreciate that additional modifications, as well as adaptations for particular circumstances, will fall within the scope of the invention as herein shown and described and the claims appended hereto.

What is claimed is:

1. A vehicle wheel assembly comprising:
a hub carrier;
a hub rotatable relative to the hub carrier about a hub axis;
a brake rotor releasbly secured to the hub;
a wheel rim releasably secured to the hub;
a mounting mechanism releasably engaged to secure the wheel rim and the brake rotor to the hub; and
a brake caliper assembly slidably mounted to the hub carrier and adapted to selectively engage the brake rotor using brake pads;
wherein, with the mounting mechanism disengaged, the brake caliper assembly is slidably displaceable such that the brake rotor can be removed from the hub without removing the brake caliper assembly from the hub carrier.

2. The assembly of claim 1, further comprising an attachment mechanism releasably engaged to secure the brake rotor to the wheel rim independently of the mounting mechanism.

3. The assembly of claim 2, wherein the mounting mechanism includes a first stud attached to the hub and extending through aligned first openings in the brake rotor and the wheel rim, and a first nut threaded onto the first stud; and
wherein the attachment mechanism includes a second stud attached to the brake rotor and extending through a second opening in the wheel rim, and a second nut threaded onto the second stud.

4. The assembly of claim 2, wherein the attachment mechanism includes adjacent collars extending from the brake rotor and wheel rim with aligned openings defined therein, and an engagement arm removably inserted through the aligned openings.

5. The assembly of claim 1, wherein the brake caliper assembly is slidably displaceable in a direction substantially perpendicular to the hub axis to allow removal of the brake rotor from the hub.

6. The assembly of claim 1, wherein the brake caliper assembly is slidably displaceable in a direction substantially parallel to the hub axis to allow removal: of the brake rotor from the hub.

7. The assembly of claim 6, wherein the brake caliper assembly includes a caliper mounting post for guiding sliding motion between the brake caliper assembly and the hub carrier.

8. The assembly of claim 7, wherein the caliper mounting post is attached to the hub carrier and slidable relative to the brake caliper assembly.

9. The assembly of claim 8, wherein the brake caliper assembly has a mounting bore defined therein, and the caliper mounting post extends through the mounting bore.

10. A method of using the assembly of claim 1, the method comprising:
disengaging the mounting mechanism;
removing the wheel rim;
simultaneously pulling the brake rotor and the brake caliper assembly away from the hub; and
moving the brake rotor clear of the brake caliper assembly when the brake rotor is clear of the hub.

11. The method of claim 10, wherein the wheel rim remains connected to the brake rotor, and removing the wheel rim is performed simultaneously with pulling and moving the brake rotor.

12. The method of claim 10, further comprising replacing the brake rotor after removal with a replacement brake rotor.

13. The method of claim 12, wherein the replacement brake rotor is connected to the wheel rim, or to a replacement wheel rim, before replacing.

14. A brake caliper assembly for a vehicle wheel, the assembly comprising:
a caliper body having a cylinder defined therein;
a piston arranged therein and adapted to selectively displace a brake pad to engage brake rotor;
a caliper mounting post adapted for slidably mounting the caliper body to a hub carrier of a vehicle wheel assembly;
wherein the caliper mounting post is dimensioned to allow sufficient slidable displacement of the caliper body relative to the hub carrier such that the brake rotor can be removed from the vehicle wheel assembly without removal of the brake caliper assembly from the hub carrier.

15. The assembly of claim 14, wherein the wherein the caliper body has a mounting bore defined therein, and the caliper mounting post extends through the mounting bore and is slidable relative thereto.

16. The assembly of claim 15, further comprising an additional caliper mounting post;
wherein the caliper body has an additional mounting bore defined therein, and the additional caliper mounting post extends through the additional mounting bore and is slidable relative thereto.

17. The assembly of claim 14, wherein a cooling fluid passage adjacent to the cylinder is also defined within the caliper body.

18. The assembly of claim 17, wherein the cooling fluid passage has sections arranged concentrically around the cylinder.

19. The assembly of claim 17, further comprising a caliper head removably secured to the caliper body and having a brake fluid port and a cooling fluid port extending therethrough in fluid communication with the cylinder and the cooling fluid passage, respectively.

20. The assembly of claim 19, wherein an additional cooling fluid port extends through the caliper body in fluid communication with the cooling fluid passage, such that cooling fluid can flow through the cooling fluid passage between the cooling fluid port and the additional cooling fluid port.
